(19) United States
(12) Patent Application Publication
(10) Pub. No.: US 2005/0179396 A1
(43) Pub. Date: Aug. 18, 2005

(54) Carbon nano tube field emission display and driving method thereof

(75) Inventor: Seong-Hak Moon, Seoul (KR)

Correspondence Address: JONATHAN Y. KANG, ESQ.;LEE, HONG, DEGERMAN, KANG & SCHMADEKA, 14th Floor, 801 S. Figueroa Street, Los Angeles, CA, 90017, US

(73) Assignee: LG Electronics Inc.

(21) Appl. No.: 11/050,307

(22) Filed: Feb. 1, 2005

(30) Foreign Application Priority Data
Feb. 25, 2004 (KR) 12724/2004
Feb. 17, 2004 (KR) 10434/2004

(51) Int. Cl. H05B 37/00

(52) U.S. Cl. 315/167; 313/309

(57) ABSTRACT

A carbon nano tube (CNT) field emission display (FED) and its driving method enhance discharge efficiency by forming an auxiliary electrode that is separated by a certain distance from a cathode electrode and parallel to the cathode electrode on the same plane.

### BACKGROUND OF THE INVENTION

1. Field of the Invention

The present invention relates to a field emission display (FED) and, more particularly, to a carbon nano tube (CNT) FED and its driving method.

2. Description of the Related Art

Importance of a next-generation multimedia display unit as a visual information transfer means is increasing according to development and spreading of an information processing system. As the CRT (Cathode Ray Tube) is not suitable for the recent trend aiming at large and flat screen, researches and development on various flat panel displays (FPD) such as an LCD (Liquid Crystal Display), a FED (Field Emission Display), a PDP (Plasma Display Panel), an EL (Electro-Luminescence) or the like are actively ongoing.

In particular, a large and flat screen, a low price, high performance and light weight are essential factors, so development of a light, thin flat display that may substitute the existing CRT is greatly required.

In line with the various requirements, recently, a device using field emission is applied to the display sector and a thin film display, and a thin film display that can provide high resolution while reducing the size and power consumption of a product is under development.

Of the flat panel display devices, the FED receives an attention as a next-generation information communication flat panel display device that can overcome every shortcomings of the flat panel display devices and is expected to be put to practical use in the near future. Namely, the FED has a simple electrode structure, operates at a high speed, and has the merits of the CRT having high luminance and wide view angle and the merits of the LCD that can be designed to be quite thin.

Lately, importance of the FED using the CNT having the excellent mechanical characteristics, electric selectivity and excellent field emission characteristics as an electron emission source is increasingly recognized. Namely, the carbon nano tube has many advantages that since it has a smaller diameter (approximately 1.0˜scores of nm), its field enhancement factor is excellent compared to a micro tip, and since electrons are emitted at a low turn-on field (approximately 1.0˜5.0V/μm), a power loss and production cost of its product can be reduced.

The related art CNT FED can be divided to an undergate structure type and a counter electrode coplanar structure type depending on a form of the gate electrode, which will now be described with reference to FIGS. 1 and 2.

FIG. 1 is a sectional view showing a unit cell of the related art CNT FED having the undergate structure.

As shown in FIG. 1, the unit cell of the related art CNT FED having the undergate structure includes: a front substrate 10 including an anode electrode 12 and a phosphor layer 13 sequentially stacked on an upper glass substrate 11; and a back substrate 20 including a gate electrode 24, a dielectric layer 23, a cathode electrode 22 and a CNT 21 sequentially stacked on a lower glass substrate 25.

However, although the CNT FED having such an undergate structure has a quite easy and simple fabrication process, it has the following problems. That is, since a high voltage needs to be applied to the gate electrode 24 and the cathode electrode 22 positioned at different layers, much power is consumed and discharge efficiency is low, and in addition, since electric charge is charged in the dielectric layer 23 positioned between the gate electrode 24 and the cathode electrode 22, an abnormal emission phenomenon occurs.

Thus, in order to lower the voltage applied to the gate electrode and the cathode electrode in driving the related art CNT FED having the undergate structure, the CNT FED having the counter electrode coplanar structure has been proposed.

FIG. 2 illustrates a sectional view showing a unit cell of the related art CNT FED having the counter electrode coplanar structure.

As shown in FIG. 2, the unit cell of the related art CNT FED having the counter electrode coplanar structure includes: a front substrate 10 having an anode electrode 12 and a phosphor layer 13 sequentially stacked on an upper glass substrate 11; and a back substrate 20 having a first gate electrode 24, a dielectric layer 23, a cathode electrode 22, a second gate electrode 27 and a carbon nano tube 21 sequentially stacked on a lower glass substrate 25.

The second gate electrode 27 is connected to the first gate electrode 24 through a via hole 26 formed in the dielectric layer 23 and formed side by side with the cathode electrode 22 on the dielectric layer 23. The second gate electrode 27 is also called a counter electrode.

The related art CNT FED having the counter electrode coplanar structure is advantageous in that since a voltage applied to the first and second gate electrodes 24 and 27 and to the cathode electrode 22 is relatively low, power consumption is reduced and such an abnormal emission phenomenon caused by electric charges charged in the dielectric layer 23 between the first and second gate electrodes 24 and 27 and the cathode electrode 22 can be prevented.

In addition, the related art CNT FED having the counter electrode coplanar structure is also advantageous in that the second gate electrode 27 is formed side by side with the cathode electrode 22 so that discharge efficiency is enhanced.

However, the related art CNT FED having the counter electrode coplanar structure has shortcomings that since the via hole 26 is formed to connect the first and second gate electrodes 24 and 27, processes with a high level of difficulty causing a low yield and increase in a fabrication cost are to be performed.

To sum up, as mentioned above, the CNT FED having the undergate structure has the problem that since the gate electrode, the dielectric layer and the cathode electrode are sequentially formed, the high voltage needs to be applied to the gate electrode and the cathode electrode that are positioned at different layers, and thus, much power is consumed and the discharge efficiency is low. In addition, since electric charges are charged in the dielectric layer positioned between the gate electrode and the cathode electrode, the abnormal emission phenomenon takes place.

Second, the CNT FED having the counter electrode coplanar structure has the problem that since the second gate electrode is formed connected with the first gate electrode through the via hole side by side with the cathode electrode on the dielectric layer, the via hole needs to be formed to connect the first and second gate electrodes, and thus, the processes with a high level of difficulty causing a low yield and increase in a fabrication cost are to be performed.

### SUMMARY OF THE INVENTION

Therefore, one object of the present invention is to provide a carbon nano tube (CNT) field emission display (FED) and its driving method capable of enhancing discharge efficiency by forming an auxiliary electrode that is separated by a certain distance from a cathode electrode and parallel to the cathode electrode on the same plane.

Another object of the present invention is to provide a CNT FED and its driving method capable of preventing an abnormal emission phenomenon by forming an auxiliary electrode that is separated by a certain distance from a cathode electrode and parallel to the cathode electrode on the same plane.

Still another object of the present invention is to provide a CNT FED and its driving method capable of reducing power consumption by forming an auxiliary electrode that is separated by a certain distance from a cathode electrode and parallel to the cathode electrode on the same plane.

Yet another object of the present invention is to provide a CNT FED and its driving method capable of simplifying a fabrication process by forming an auxiliary electrode that is separated by a certain distance from a cathode electrode and parallel to the cathode electrode on the same plane.

To achieve at least the above objects in whole or in parts, there is provided a CNT FED including an auxiliary electrode that is separated by a certain distance from a cathode electrode and parallel to the cathode electrode on the same plane.

To achieve at least these advantages in whole or in parts, there is further provided a CNT FED including: a gate electrode formed at an upper portion of a lower glass substrate; a dielectric layer formed at an upper portion of the gate electrode; a cathode electrode formed at an upper portion of the dielectric layer; an auxiliary electrode separated by a certain distance from the cathode electrode and formed parallel at one side of the cathode electrode; and a certain number of CNTs formed at an upper portion of the cathode electrode.

To achieve at least these advantages in whole or in parts, there is further provided a method for driving CNT FED including: applying a positive (+) voltage when a voltage is applied to a gate electrode and a cathode electrode; and applying a negative (−) voltage when the voltage is applied to the gate electrode and the cathode electrode.

Additional advantages, objects, and features of the invention will be set forth in part in the description which follows and in part will become apparent to those having ordinary skill in the art upon examination of the following or may be learned from practice of the invention. The objects and advantages of the invention may be realized and attained as particularly pointed out in the appended claims.

### BRIEF DESCRIPTION OF THE DRAWINGS

The invention will be described in detail with reference to the following drawings in which like reference numerals refer to like elements wherein:

FIG. 1 is a sectional view showing a unit cell of a related art CNT FED having an undergate structure;

FIG. 2 is a sectional view showing a unit cell of a related art CNT FED having a counter electrode coplanar structure;

FIG. 3 is a sectional view showing a pixel cell of a CNT FED in accordance with a first embodiment of the present invention;

FIG. 4 is a plan view showing the structure of the CNT FED in accordance with the first embodiment of the present invention;

FIG. 5 shows waveforms for explaining a method for driving the CNT FED of FIG. 4 in accordance with the first embodiment of the present invention;

FIG. 6 is a plan view showing the structure of the CNT FED in accordance with a second embodiment of the present invention;

FIG. 7 is a sectional view showing a pixel cell of the CNT FED in accordance with a third embodiment of the present invention;

FIG. 8 is a plan view showing the structure of the CNT FED in accordance with the third embodiment of the present invention;

FIGS. 9A and 9B show waveforms for explaining a method for driving the CNT FED of FIG. 8 in accordance with the third embodiment of the present invention; and

FIGS. 10A to 10D are sectional views showing various forms of the CNT FED in accordance with the present invention.

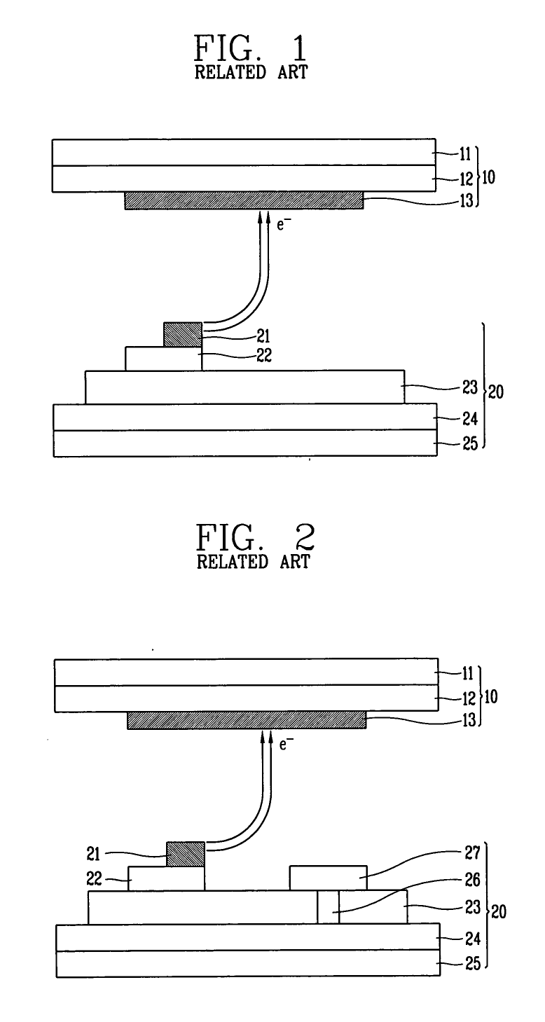

### DETAILED DESCRIPTION OF THE PREFERRED EMBODIMENTS

The CNT FED capable of preventing discharge efficiency, preventing an abnormal emission phenomenon, reducing power consumption and simplifying a fabrication process by forming an auxiliary electrode separated by a certain distance from a cathode electrode and parallel to the cathode electrode, in accordance with first to third embodiments of the present invention will now be described.

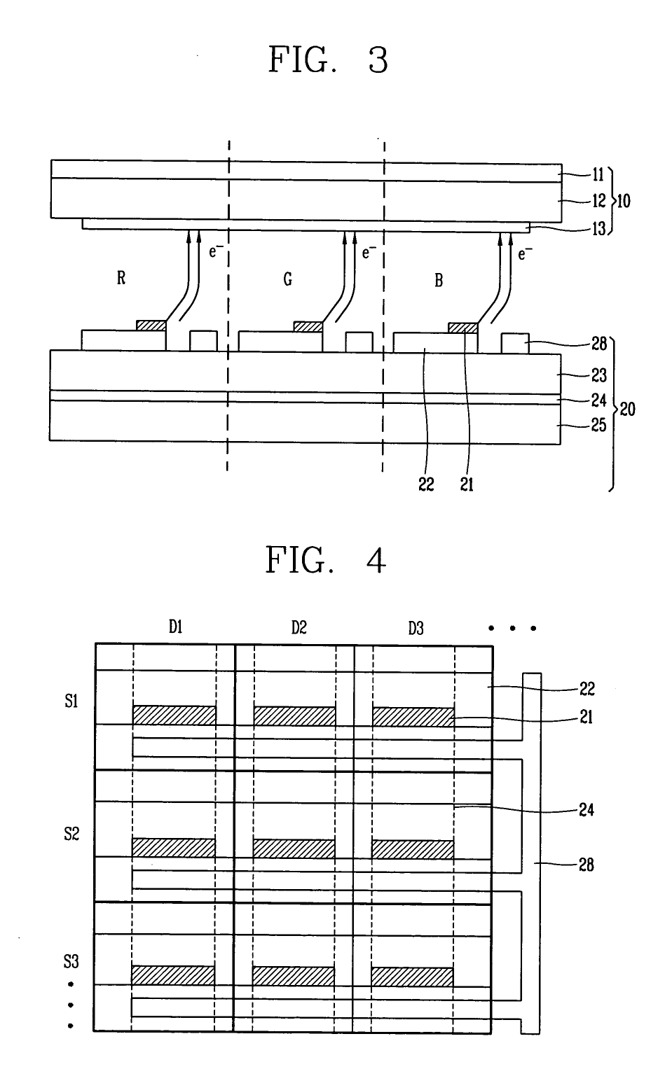

FIG. 3 is a sectional view showing a pixel cell of a CNT FED in accordance with a first embodiment of the present invention.

As shown in FIG. 3, a pixel cell of the CNT FED in accordance with the first embodiment of the present invention, includes an R, G and B unit cells, each including: a front substrate 10 having an anode electrode 12 and a phosphor layer 13 sequentially stacked on the upper portion of an upper glass substrate 11; and a back substrate 20 having a gate electrode 24, a dielectric layer 23, a cathode electrode 22, a auxiliary electrode 28 and a carbon nano tube (CNT) 21 sequentially stacked on a lower glass substrate 25.

The auxiliary electrode 28 is formed separated by a certain distance from and parallel to the cathode electrode 22, and the CNT 21 is formed at a boundary of one side of the cathode electrode 22 adjacent to the auxiliary electrode 28.

The operational principle of the CNT FED in accordance with the first embodiment of the present invention will now be described.

First, when a certain voltage is applied to the gate electrode 24 and the cathode electrode 22, electrons are emitted from the CNT 21 by virtue of quantum-mechanical tunneling effect. Namely, when the applied voltage is relatively high, the amount of electrons emitted from the CNT 21 increases, while if the applied voltage is relatively low, the amount of electrons emitted from the CNT 21 decreases.

At this time, the auxiliary electrode 28 helps to apply a positive (+) voltage to the gate electrode 22 and the cathode electrode 24, so that the amount of electrons emitted from the CNT 21 can be increased. The auxiliary electrode 28 is formed such that a conductive material is formed at the entire upper surface of the dielectric layer 23 and then patterned to form the cathode electrode 22 and the auxiliary electrode 28 which is isolated by a certain distance from and parallel to the cathode electrode 22.

Thereafter, electrons emitted from the CNT 21 are accelerated toward the anode 12 with the phosphor layer 13 coated thereon by being affected by electric field formed by the high voltage applied to the anode electrode 12, so that the electrons collide with the phosphor layer 13 to generate an energy. Electrons existing in the phosphor layer 13 are excited by the generated energy to emit R, G and B visible lights.

The structure of the CNT FED in accordance with the first embodiment of the present invention will be described.

FIG. 4 is a plan view showing the structure of the CNT FED in accordance with the first embodiment of the present invention.

As shown in FIG. 4, a plurality of scan lines (S1-S3) and a plurality of data lines (D1-D3) cross vertically and one unit cell is formed at each crossing of the scan lines and data lines. The thusly formed unit cells are sequentially arranged in the order of R, G and B at every crossing of the scan lines and data lines. The three sequentially arranged R, G and B unit cells form one pixel cell. The auxiliary electrode 28 is formed parallel to the scan lines (S1-S3). The auxiliary electrode 28 is electrically connected and receives the same voltage. The scan liens (S1-S3) mean the cathode electrodes of the CNT FED and the data lines (D1-D3) mean gate electrodes of the CNT FED.

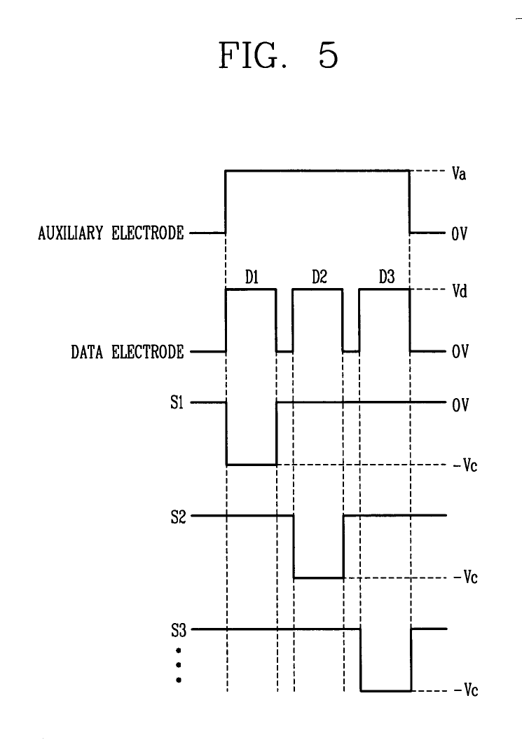

A driving method of the CNT FED in accordance with the first embodiment of the present invention constructed as described above will now be explained with reference to FIG. 5.

FIG. 5 shows waveforms for explaining a method for driving the CNT FED of FIG. 4 in accordance with the first embodiment of the present invention.

As shown in FIG. 5, in the CNT FED in accordance with the first embodiment of the present invention, the positive (+) voltage (Vₐ) is continuously applied to the auxiliary electrode during a driving time while a data voltage (Vd) is applied to the data lines (D1-D3) and a scan voltage (−V_{c}) is applied to the scan lines (S1-S3), but a ground voltage (0V) is applied to the auxiliary electrode while the scan voltage (−V_{c}) is not applied to the scan lines (S1-S3).

In this case, since the positive (+) voltage is applied to the auxiliary electrode while the scan lines (S1-S3) are being sequentially driven, to thereby increase the amount of electrons discharged from the CNT 21. Thus, discharge efficiency of the CNT FED can be enhanced.

While the scan lines S1-S3 are not driven, the ground voltage, namely, 0V, is applied to the auxiliary electrode 28 to offset electric field formed by the anode electrode 12 and the cathode electrode 22, so that an abnormal emission phenomenon due to the high voltage applied to the anode electrode 12 can be prevented.

In addition, the auxiliary electrode 28 can reduce the voltage for driving the CNT FED according to the first embodiment of the present invention in consideration of discharge efficiency increased by the additionally applied certain positive (+) voltage. Herein, the voltage applied to the gate electrode 24 and the cathode electrode 22 and the voltage applied to the auxiliary electrode 28 are related to a distance between the auxiliary electrode 28 and the cathode electrode 22. Thus, the disposition of the auxiliary electrode 28, the voltage applied to the gate electrode 24 and the cathode electrode 22 and the voltage applied to the auxiliary electrode 28 must be determined in consideration of the relationship.

The structure of the CNT FED in accordance with a second embodiment of the present invention will now be described.

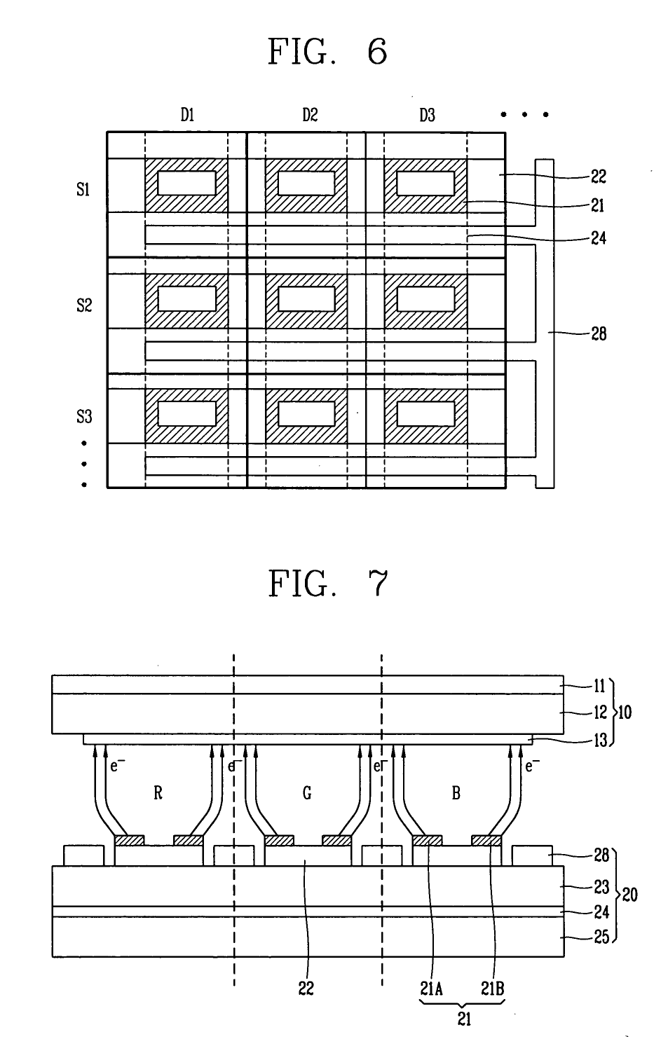

FIG. 6 is a plan view showing the structure of the CNT FED in accordance with a second embodiment of the present invention.

As shown in FIG. 6, in the CNT FED in accordance with the second embodiment of the present invention, the CNT 21 formed at an upper portion of the cathode electrode 22 has a rectangular closed loop form, so as to emit relatively more electrons with the same voltage applied to the gate electrode 24 and the cathode electrode 22 and thus enhance the discharge efficiency.

Preferably, one side of the CNT 21 in the rectangular closed loop form is positioned at the boundary of the cathode electrode 22 adjacent to the auxiliary electrode 28.

The structure of a pixel cell of the CNT FED in accordance with a third embodiment of the present invention will now be described with reference to FIG. 7.

FIG. 7 is a sectional view showing a pixel cell of the CNT FED in accordance with a third embodiment of the present invention.

As shown in FIG. 7, a pixel of a CNT FED in accordance with the third embodiment of the present invention, includes R, G and B unit cells each including: a front substrate 10 having an anode electrode 12 and a phosphor layer 13 sequentially stacked on an upper glass substrate 11; and a back substrate 20 having a gate electrode 24, a dielectric layer 23, a cathode electrode 22, a auxiliary electrode 28 and a plurality of CNTs 21A and 21B sequentially stacked on the lower glass substrate 25.

The auxiliary electrode 28 is formed at both sides of the cathode electrode 22 with a certain distance therebetween and has a large width in parallel. The plurality of CNTs 21 are formed side by side at boundary portions of both sides of the cathode electrode 22 adjacent to the auxiliary electrode 28.

The operational principle of the CNT FED in accordance with the third embodiment of the present invention is the same as of the first embodiment of the present invention, detailed descriptions of which are, thus, omitted.

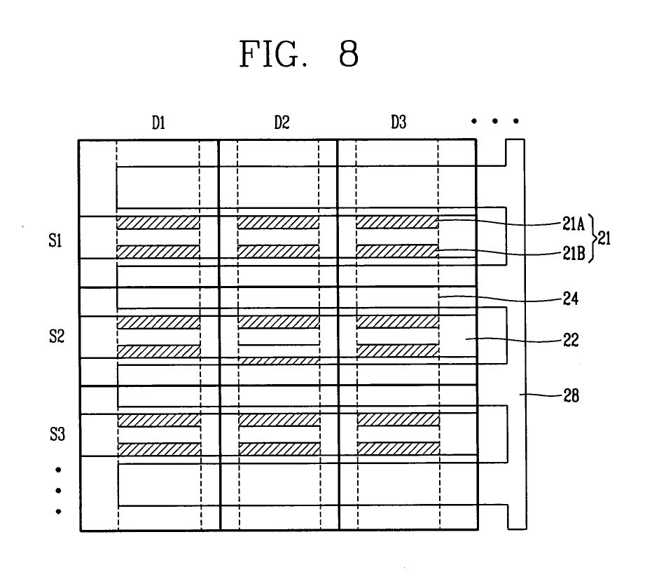

The structure of the CNT FED including the pixel cells in accordance with the present invention will now be described with reference to FIG. 8.

FIG. 8 is a plan view showing the structure of the CNT FED in accordance with the third embodiment of the present invention.

As shown in FIG. 8, in the CNT FED in accordance with the third embodiment of the present invention, a plurality of CNTs 21A and 21B are formed at an upper portion of the cathode electrode 22 and a auxiliary electrode 28 adjacent to the plurality of CNTs 21A and 21B is formed at boundary portions of both sides of the cathode electrode 22. Preferably, two CNTs 21 having the same size are formed.

Accordingly, in the CNT FED in accordance with the third embodiment of the present invention, since the two CNTs are formed at the upper portion of the cathode electrode 22, the amount of electrons emitted from the CNTs 21A and 21B can be increased, and since the wide auxiliary electrode 28 is formed at the position spaced apart from the cathode electrode 22, electric charges charged in the dielectric layer 23 can be reduced. Thus, an abnormal emission phenomenon can be prevented and the voltage applied to cathode electrode 22 and the gate electrode 24 can be redced.

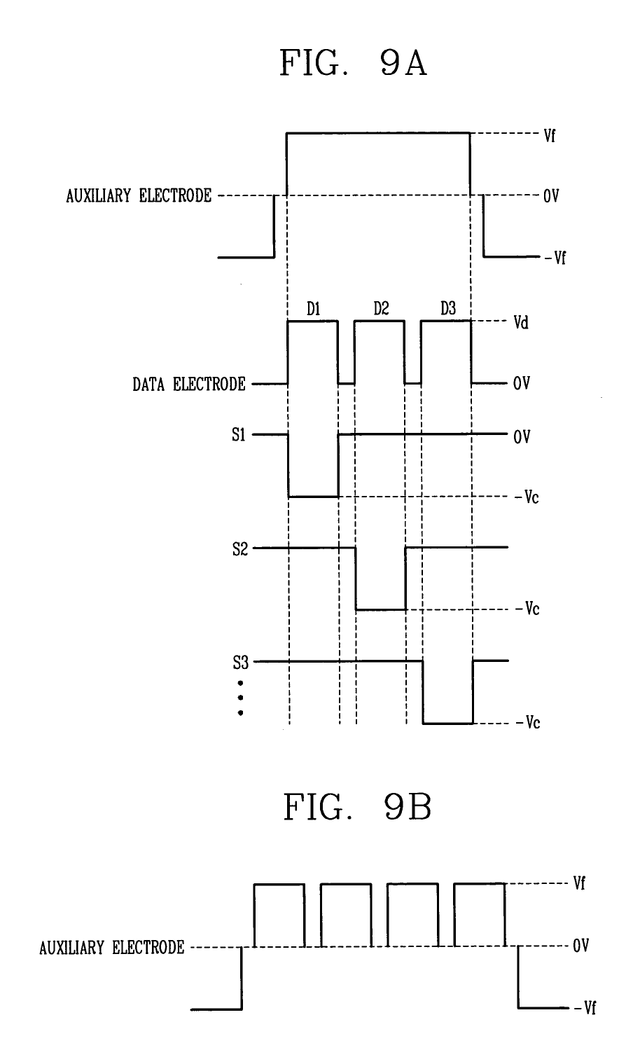

A method for driving the TNT FED in accordance with the third embodiment of the present invention will now be described with reference to FIGS. 9A and 9B.

FIGS. 9A and 9B show waveforms for explaining a method for driving the CNT FED of FIG. 8 in accordance with the third embodiment of the present invention.

As shown in FIG. 9A, in the CNT FED in accordance with the third embodiment of the present invention, a positive (+) voltage (Vf) is continuously applied to the auxiliary electrode during the driving time when a data voltage (Vd) is applied to the data lines D1-D3 and sequentially a scan voltage (−Vc) is applied to the scan lines S1-S3, but a negative (−) voltage (−Vf) is applied to the auxiliary electrode while the scan voltage (−Vc) is not applied to the scan lines (S1-S3).

In this case, when the negative (−) voltage (−Vf) applied to the auxiliary electrode is converted into the positive voltage (Vf) or when the positive (+) voltage (Vf) is converted into the negative (−) voltage (−Vf), no voltage is applied to the auxiliary electrode during a predetermined time to thereby offset electric field formed by the voltage applied to the anode electrode 12 and the CNT 21.

With reference to FIG. 9B, in the CNT FED in accordance with the third embodiment of the present invention, the positive (+) voltage (Vf) is applied in a pulse form to the auxiliary electrode during the driving time when the data voltage (Vd) is applied to the data lines D1-D3 and sequentially the scan voltage (−Vc) is applied to the scan lines S1-S3, but the negative (−) voltage (−Vf) is applied to the auxiliary electrode while the scan voltage (−Vc) is not applied to the scan lines S1-S3. In this case, the size of the positive (+) voltage Vf and the negative (−) voltage (−Vf) can be set to be different.

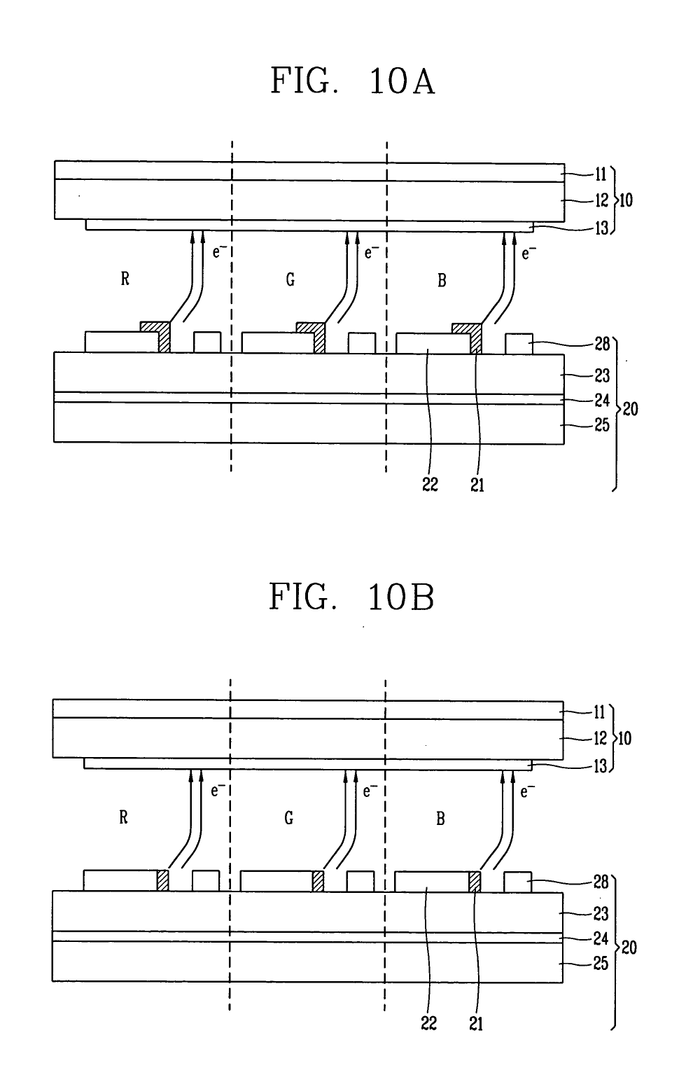

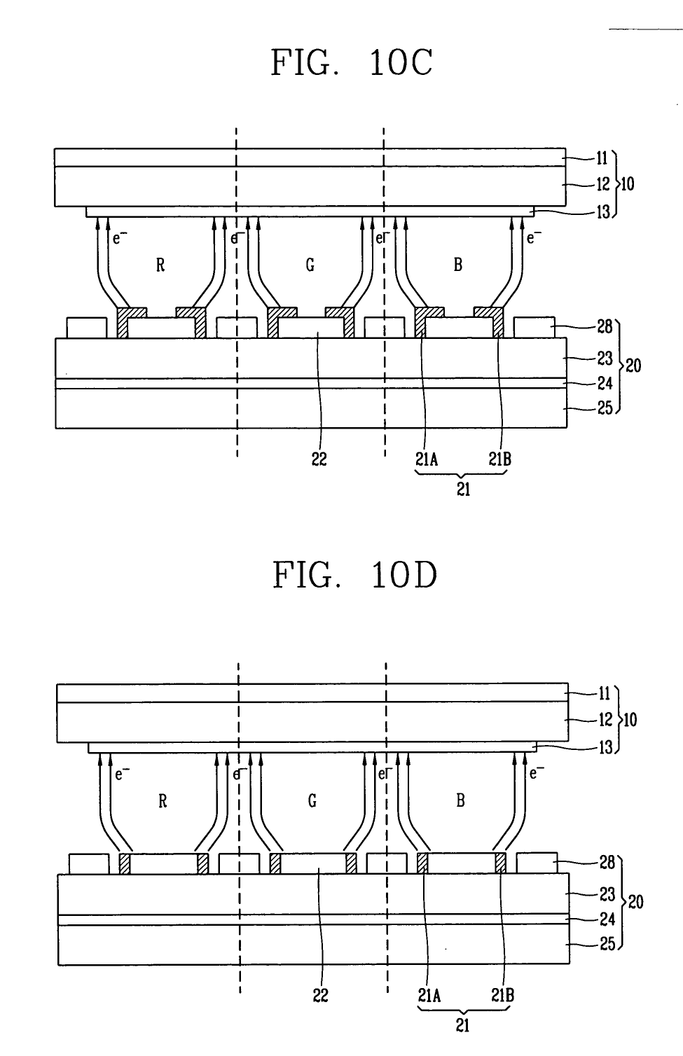

Additionally, there can be various CNT FED forms besides the CNT FEDs in accordance with the first to third embodiments of the present invention. Various forms of CNT FED in accordance with the present invention will now be described with reference to FIGS. 10A to 10D.

FIGS. 10A to 10D are sectional views showing various forms of the CNT FED in accordance with the present invention.

As shown in FIGS. 10A to 10A, in the CNT FED, the CNT can be formed to be connected to a portion of an upper surface or a side surface of the cathode electrode 22, or the CNT can be formed at one side surface of the cathode electrode 22. The formed CNT can be formed at one side and the other side of the cathode electrode 22 in the same form.

As so far described, the CNT FED and its driving method in accordance with the present invention have many advantages.

That is, for example, first, since the auxiliary electrode 28 is formed at one side of the cathode electrode 22 with a certain distance therebetween and parallel to the cathode electrode 22 on the same plane, the amount of electrons emitted from the CNT 21 increases, and thus, the discharge efficiency can be enhanced.

Second, since the auxiliary electrode 28 is formed at one side of the cathode electrode 22 with a certain distance therebetween and parallel to the cathode electrode 22 on the same plane, the electric charge charged in the dielectric layer 23 can be reduced, and thus, an abnormal emission phenomenon can be prevented.

Third, since the auxiliary electrode 28 is formed at one side of the cathode electrode 22 with a certain distance therebetween and parallel to the cathode electrode 22 on the same plane, no voltage is applied to the auxiliary electrode 28, and thus, power consumption can be reduced.

Fourth, since the auxiliary electrode 28 is formed at one side of the cathode electrode 22 with a certain distance therebetween and parallel to the cathode electrode 22 on the same plane, an additional process is not required, and thus, a fabrication process can be simplified.

The foregoing embodiments and advantages are merely exemplary and are not to be construed as limiting the present invention. The present teaching can be readily applied to other types of apparatuses. The description of the present invention is intended to be illustrative, and not to limit the scope of the claims. Many alternatives, modifications, and variations will be apparent to those skilled in the art. In the claims, means-plus-function clauses are intended to cover the structure described herein as performing the recited function and not only structural equivalents but also equivalent structures.

1. A CNT (Carbon Nano Tube) FED (Field Emission Display) comprising:
an auxiliary electrode that is separated by a certain distance from a cathode electrode and parallel to the cathode electrode on the same plane.

2. The device of claim 1, further comprising:
a CNT formed at an upper portion of the cathode electrode.

3. The device of claim 2, wherein the CNT is formed at a boundary of one side of the cathode electrode so as to be adjacent to the auxiliary electrode.

4. The device of claim 1, wherein the certain distance is determined by a voltage applied to the cathode electrode and a voltage applied to the auxiliary electrode.

5. The device of claim 2, wherein the CNT has a rectangular closed loop form.

6. The device of claim 1, further comprising:
a plurality of CNTs formed at an upper portion of the cathode electrode.

7. The device of claim 6, wherein the CNTs are formed at boundary portions of one side and the other side of the cathode electrode, isolated by a certain distance and parallel to each other.

8. The device of claim 7, further comprising:
a auxiliary electrode separated by a certain distance from the other side of the cathode electrode and formed parallel to the cathode electrode.

9. The device of claim 1, further comprising:
a CNT formed at one side of the cathode electrode.

10. The device of claim 9, further comprising:
a CNT formed at the other side of the cathode electrode

11. The device of claim 1, further comprising:
a CNT formed at one upper portion of the cathode electrode, being extended from one side of the cathode electrode.

12. The device of claim 11, further comprising:
a CNT formed at one upper portion of the cathode electrode, being extended from the other side of the cathode electrode.

13. A CNT (Carbon Nano Tube) FED (Field Emission Device) comprising:
a gate electrode formed at an upper portion of a lower glass substrate;
a dielectric layer formed at an upper portion of the gate electrode;
a cathode electrode formed at an upper portion of the dielectric layer;
an auxiliary electrode separated by a certain distance from the cathode electrode and formed parallel at one side of the cathode electrode; and
a certain number of CNTs formed at an upper portion of the cathode electrode.

14. The device of claim 13, wherein the CNT is formed at a boundary of one side of the cathode electrode so as to be adjacent to the auxiliary electrode.

15. The device of claim 13, wherein the CNT has a rectangular closed loop form.

16. The device of claim 13, wherein there are formed two or more CNTs.

17. The device of claim 16, wherein the CNTs are formed at boundary portions of one side and the other side of the cathode electrode, isolated by a certain distance and parallel to each other.

18. The device of claim 17, further comprising:
a auxiliary electrode separated by a certain distance from the other side of the cathode electrode and formed parallel to the cathode electrode.

19. The device of claim 13, wherein when a voltage is applied to the gate electrode and the cathode electrode, a certain positive (+) voltage is applied to the auxiliary electrode.

20. The device of claim 19, wherein when a voltage is not applied to the gate electrode and the cathode electrode, a ground voltage is applied to the auxiliary electrode.

21. The device of claim 19, wherein when a voltage is not applied to the gate electrode and the cathode electrode, a certain negative (−) voltage is applied to the auxiliary electrode.

22. A method for driving CNT (Carbon Nano Tube) FED (Field Emission Display) comprising:
applying a positive (+) voltage when a voltage is applied to a gate electrode and a cathode electrode; and
applying a negative (−) voltage when the voltage is applied to the gate electrode and the cathode electrode.

23. The method of claim 22, wherein when a positive (+) voltage applied to the auxiliary electrode is converted into a negative (−) voltage or when a negative (−) voltage is converted into a positive (+) voltage, a voltage is not applied to the auxiliary electrode for a predetermined time.
